(19) United States
(12) Patent Application Publication
(10) Pub. No.: US 2015/0120136 A1
(43) Pub. Date: Apr. 30, 2015

(54) SMART DEVICE EXECUTING APPLICATION PROGRAM BY OCCUPANT DETECTION

(71) Applicant: HYUNDAI MOTOR COMPANY, SEOUL (KR)

(72) Inventors: Woochul Jung, Seoul (KR); Young Woo Choi, Incheon (KR)

(21) Appl. No.: 14/319,253

(22) Filed: Jun. 30, 2014

(30) Foreign Application Priority Data
Oct. 25, 2013 (KR) 10-2013-0128042

(51) Int. Cl. H04W 4/00; B60N 2/00

(52) U.S. Cl. CPC H04W 4/003; B60N 2/002
USPC 701/36

(57) ABSTRACT

A smart device that determines whether an occupant is present within a vehicle is provided. The smart device includes a boarding detector that is configured to detect whether an occupant is present within a vehicle by detecting a connection with a connectivity module disposed within the vehicle or connectivity module connected to an on board diagnostics (OBD) connector. In addition, a controller is configured to execute a predetermined application program when the occupant is detected by the boarding detector.

### CROSS-REFERENCE TO RELATED APPLICATION

This application claims priority to and the benefit of Korean Patent Application No. 10-2013-0128042 filed in the Korean Intellectual Property Office on Oct. 25, 2013, the entire contents of which are incorporated herein by reference.

### BACKGROUND

(a) Field of the Invention

The present invention relates to a smart device configured to execute a related application program by detecting an occupant. More particularly, the present invention relates to a smart device that detects whether an occupant including a driver or a passenger is presented within a vehicle and executes the related application program through a control signal without direct operation of smart device by the occupant.

(b) Description of the Related Art

With the growing number of smart devices like smartphones and tablet computers, various application programs have been developed. Particularly, application programs for use within a vehicle have been developed for using an on board diagnostics (OBD) connector disposed within the vehicle. However, since a driver is required to directly operate a vehicle-specific application program executed in a smart device while driving the vehicle, safe driving may not be ensured. Additionally, operation of a smart device while driving may violate particular safety regulations, and accidents may occur by operation of the smart device while the vehicle is being driven. Accordingly, a process of interconnecting a controller within a vehicle and the smart device has been developed. However, such a process increases manufacturing cost since the controller within a vehicle is customized for the smart device.

The above information disclosed in this section is merely for enhancement of understanding of the background of the invention and therefore it may contain information that does not form the prior art that is already known in this country to a person of ordinary skill in the art.

### SUMMARY

The present invention provides a smart device configured to detect whether an occupant having a smart device is present within a vehicle (e.g., enters a vehicle), and automatically executes a related application program. Additionally, the present invention provides a smart devise configured to receive a control signal of an occupant and automatically execute an application program without direct operation of the smart device by the user after detecting an occupant within a vehicle.

A smart device according to an exemplary embodiment of the present invention may include: an entrance detector configured to detect whether an occupant has boarded (e.g., entered, is present, etc.) a vehicle by detecting connection with a Bluetooth module (e.g., a connectivity module) disposed within the vehicle or an OBD Bluetooth module (e.g., a connectivity module) connected to an OBD connector; and an application manager (e.g., a controller) configured to execute a predetermined application program when the occupant is detected by the detector.

The smart device may further include: a sensor configured to receive an operating signal of the occupant; and a sensor detector configured to detect a received operating signal from the sensor, wherein the application manager may be configured to execute an application program based on the operating signal of the occupant detected by the sensor detector. The sensor may be any one of a microphone configured to detect a sound signal generated by the occupant, a magnetic sensor configured to detect a magnetic signal generated by operation of the occupant, and a proximity sensor configured to detect a motion signal of the occupant.

The application manager may be configured to determine that the sound signal of the occupant is detected when a sound signal of the occupant received from the microphone corresponds to a predetermined sound signal, and execute a predetermined application program. The application manager may further be configured to determine that a motion signal of the occupant is detected when a motion signal of the occupant received from the proximity sensor corresponds to a predetermined motion signal, and execute predetermined application program. The application manager may be configured to set a sensing range of the proximity sensor to a maximum sensing range when the occupant is present within the vehicle, and limit a motion signal input to the proximity sensor when a motion signal of the occupant is detected.

### BRIEF DESCRIPTION OF THE DRAWINGS

The drawings are provided for reference in describing exemplary embodiments of the present invention, and the spirit of the present invention should not be construed only by the accompanying drawings.

FIG. 1 is an exemplary block diagram illustrating smart device according to an exemplary embodiment of the present invention;

FIG. 2 is an exemplary flowchart illustrating an execution process of an application program when an occupant is detected within a vehicle according to an exemplary embodiment of the present invention;

FIG. 3 is an exemplary flowchart illustrating an execution process of an application program when a sound signal is detected according to an exemplary embodiment of the present invention;

FIG. 4 is an exemplary flowchart illustrating an execution process of an application program when a motion signal is detected according to an exemplary embodiment of the present invention; and

FIG. 5 is an exemplary flowchart illustrating an execution process of an application program when a magnetic signal is detected according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In describing the present invention, parts that are not related to the description will be omitted. Like reference numerals generally designate like elements throughout the specification. In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

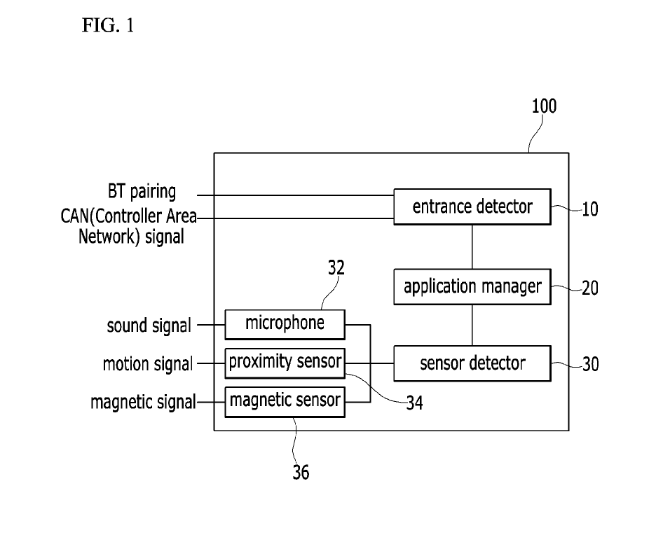

FIG. 1 is an exemplary block diagram illustrating smart device according to an exemplary embodiment of the present invention. As shown in FIG. 1, a smart device 100 according to an exemplary embodiment of the present invention may include an entrance detector 10 (e.g., a sensor) configured to detect whether an occupant has entered a vehicle (e.g., is present within a vehicle), and an application manager 20 (e.g., a controller) configured to execute a predetermined application program when the passenger is detected within the vehicle.

The entrance detector 10 may be configured to determine whether the passenger or occupant is within the vehicle using local communication with a cluster Bluetooth module disposed within a cluster of the vehicle. Alternatively, the entrance detector 10 may be configured to determine whether the occupant is within the vehicle using local communication with an OBD (on board diagnostics) Bluetooth module disposed within an OBD connector of the vehicle. In other words, the entrance detector 10 may be configured to determine whether a smart device of an occupant is within the vehicle (e.g., when a smart device is within the vehicle) through pairing with the cluster Bluetooth module or OBD Bluetooth module. When the smart device 100 is determined to be within the vehicle by pairing with the OBD Bluetooth module, vehicle status information including engine information, speed information, or fueling information may be obtained. Therefore whether the occupant enters the vehicle may be more accurately determined.

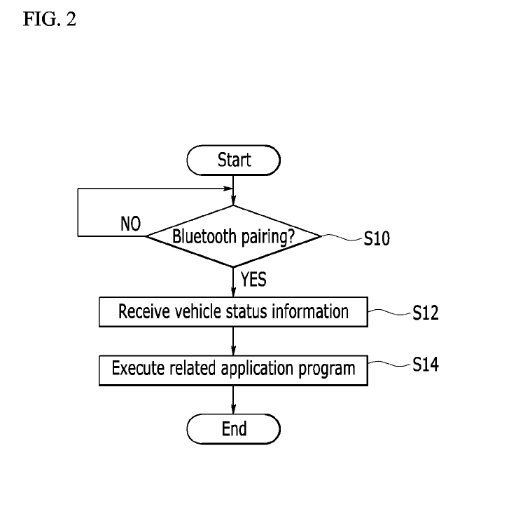

FIG. 2 is an exemplary flowchart illustrating an execution process of an application program when an occupant is detected within a vehicle according to an exemplary embodiment of the present invention. As shown in FIG. 2, the entrance detector 10 may be configured to determine whether the smart device 10 pairs with a cluster Bluetooth module or an OBD Bluetooth module disposed within the vehicle at step S10. In other words, the entrance detector 10 may be configured to determine that the occupant is within the vehicle when the smart device 100 pairs with the cluster Bluetooth module or the OBD Bluetooth module disposed within the vehicle.

When the occupant is determined to be within the vehicle by Bluetooth pairing, the application manager 20 may be configured to receive vehicle status information transferred from the OBD Bluetooth module at step S12, and execute a related application program using the received vehicle status information at step S14. For example, the application manager 20 may be configured to receive engine status information from the OBD Bluetooth module, and may be configured to execute a navigation application program based on an idle state, a driving state, or a stop state of an engine.

Additionally, the application manager 20 may be configured to receive the speed of the vehicle from the OBD Bluetooth module, and may be configured to execute a safe driving application program based on the speed of the vehicle. Further, the application manager 20 may be configured to receive fueling status information of the vehicle form the OBD Bluetooth module, and may be configured to execute a fueling service application program. The application manager 20 may not be configured to receive vehicle status information, and may then be configured to execute a predetermined application program set by the occupant when present within the vehicle (e.g., when detected to be within the vehicle).

Referring to FIG. 1, the smart device 100 according to an exemplary embodiment of the present invention may further include a sensor configured to receive an operating signal of the occupant and a sensor detector 30 configured to detect receipt of the operating signal from the sensor. The sensor may be any one of a microphone 32 configured to detect a sound signal generated by the occupant, a magnetic sensor 36 configured to detect a magnetic signal generated by operation of the occupant, or a proximity sensor 34 configured to detect a motion signal of the occupant.

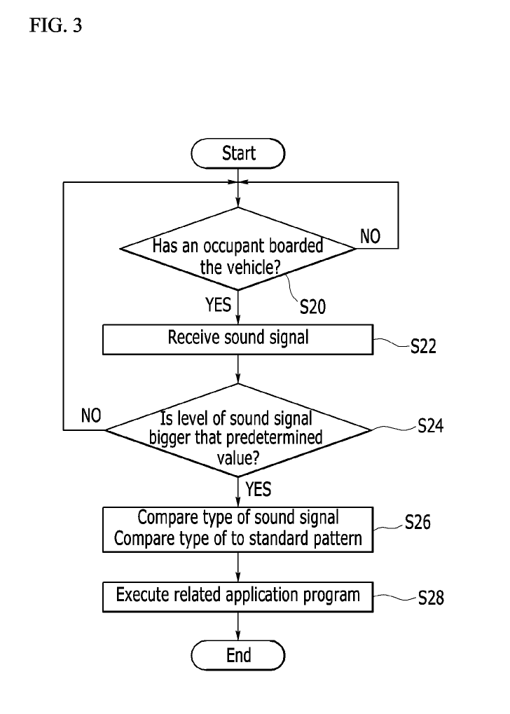

FIG. 3 is an exemplary flowchart illustrating an execution process of an application program when a sound signal is detected according to an exemplary embodiment of the present invention. As shown in FIG. 3, when presence of the occupant is determined by the detector 20 at step S20, the sensor detector 20 may be configured to receive a sound signal such as a voice signal or a knock signal (e.g., a tap) of the occupant from the microphone 32 at step S22. When a level of the sound signal is greater than a predetermined value, the sensor detector 30 may be configured to compare a pattern of the sound signal received from the microphone 32 to a standard pattern at step S26, and the application manager 20 may be configured to execute a related application program based on the type of sound signal that corresponds to the standard pattern at step S28.

For example, when the occupant knocks (e.g., taps against) a dashboard, the sensor detector 30 may be configured to determine whether a level of the knock signal is greater than a predetermined level. When the level of the knock signal is greater than a predetermined level, the sensor detector 30 may be configured to compare the type of knock signal to a predetermined type (e.g., whether the occupant knocks the dashboard once or twice, a predetermined knocking pattern or the like), and the application manager 20 may be configured to execute an application program based on the type of knock signal. The processing method to analyze the received sound signal via the microphone 32 may use a hidden Markov model (HMM), or an application program may be executed using the level of the sound signal as necessary.

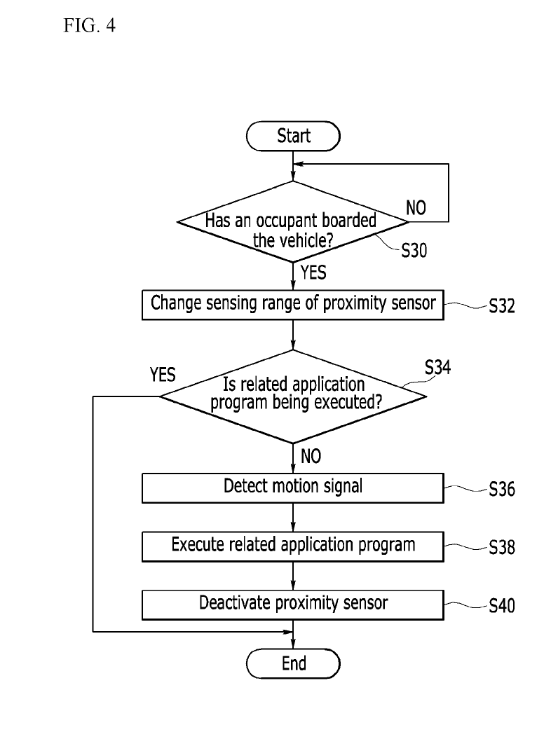

FIG. 4 is an exemplary flowchart illustrating an execution process of an application program when a motion signal is detected according to an exemplary embodiment of the present invention. As shown in FIG. 4, when the occupant is detected by the detector 20 at step S30, the application manager 20 may be configured to set a sensing range of the proximity sensor 34 to a maximum range at step S32. Generally, the detecting range of the proximity sensor 34 disposed within the smart device 100 may be within about 5 cm. In particular, the occupant may input a motion signal substantially near to the smart device. Therefore, to detect the motion signal of the occupant more easily, the detection range of the proximity sensor 34 may be to a maximum range.

When the application program is executed by detection of the motion signal, the sensor detector 30 does not receive the motion signal and when application program is not executed, then the sensor detector 30 may be configured to receive a motion signal of the occupant through the proximity sensor 34 at step S34. The sensor detector 30 may be configured to detect the type of motion signal received from the proximity sensor at step S36. For example, the sensor detector 30 may be configured to detect whether the occupant waves his hand in a horizontal direction or in a vertical direction. The application manager 20 may be configured to execute a predetermined application program according to the motion signal detected by the sensor detector 30 at step S38. When a predetermined application program is executed by detection of the motion signal, the proximity sensor may be deactivated to prevent detection of a motion signal input by the proximity sensor at step S40.

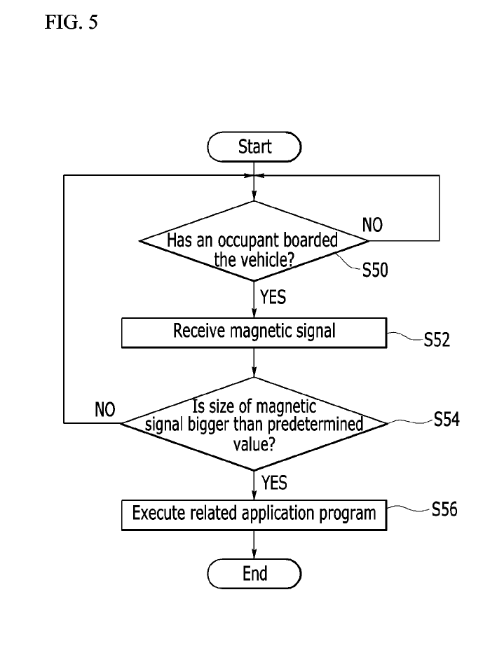

FIG. 5 is an exemplary flowchart illustrating an execution process of an application program when a magnetic signal is detected according to an exemplary embodiment of the present invention. As shown in FIG. 5, when the entrance detector 11 detects that the occupant is present within the vehicle at step S50, a magnetic signal may be received by the magnetic sensor 36 at step S52. For example, when a starting button disposed within the vehicle is pressed (e.g., engaged), a magnetic field may be generated by an electromagnet provided in a crash pad. The generated magnetic field may be input to the magnetic sensor 36. The sensor detector 30 may be configured to determine whether the size of the magnetic signal received from the magnetic sensor 36 is greater than a predetermined value at step S54. When the size of the magnetic signal is greater than the predetermined value, the application manager 20 may be configured to execute a predetermined application program at step S54.

According to an exemplary embodiment of the present invention as described above, it may be determined whether an occupant has entered a vehicle by detecting a connection state to a Bluetooth module disposed within a vehicle, and a related application program may be automatically executed. In addition, the related application program of a smart device may be automatically executed by a control signal of an occupant without direct operation of a smart device. Since the occupant does not directly operate the smart device and the related application program may be executed automatically, the driver may focus on driving the vehicle and safe driving may be obtained.

### DESCRIPTION OF SYMBOLS

10: entrance detector
20: application manager
30: sensor detector
32: microphone
34: proximity sensor
36: magnetic sensor

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A smart device, comprising:
an entrance detector configured to detect presence of occupant within a vehicle by detecting a connection with a connectivity module disposed within the vehicle or connectivity module connected to an on board diagnostics (OBD) connector; and
controller having a processor and a memory configured to execute a predetermined application program when presence of the occupant is detected.

2. The smart device of claim 1, further comprising:
a sensor configured to receive an operating signal of the occupant; and
a sensor detector configured to detect receipt of the operating signal from the sensor,
wherein the controller is configured to execute an application program according to the operating signal of the occupant detected by the sensor detector.

3. The smart device of claim 2, wherein the sensor is any one selected from a group consisting of: a microphone configured to detect a sound signal generated by the occupant, a magnetic sensor configured to detect a magnetic signal generated by operation of the occupant, and a proximity sensor configured to detect a motion signal of the occupant.

4. The smart device of claim 3, wherein the controller is configured to determine that a sound signal of the occupant is detected when a sound signal of the occupant received by the microphone corresponds to a predetermined sound signal, and execute the predetermined application program.

5. The smart device of claim 3, wherein the controller is configured to determine that a motion signal of the occupant is detected when a motion signal of the occupant received from the proximity sensor corresponds to a predetermined motion signal and execute the predetermined application program.

6. The smart device of claim 5, wherein the controller is configured to set a sensing range of the proximity sensor to a maximum sensing range in response to detecting an occupant within the vehicle, and limit motion signal input to the proximity sensor when the motion signal of the occupant is detected.

7. A method of detecting a smart device, comprising:
receiving, by a controller, a connection detection by an entrance detector to detect presence of occupant within a vehicle by detecting a connection with a connectivity module disposed within the vehicle or connectivity module connected to an on board diagnostics (OBD) connector; and
executing, by the controller, a predetermined application program when presence of the occupant is detected.

8. The method of claim 7, further comprising:
receiving, by the controller, an operating signal of the occupant from a sensor; and
executing, by the controller. an application program according to the operating signal of the occupant.

9. The method of claim 8, wherein the sensor is any one selected from a group consisting of: a microphone configured to detect a sound signal generated by the occupant, a magnetic sensor configured to detect a magnetic signal generated by operation of the occupant, and a proximity sensor configured to detect a motion signal of the occupant.

10. The method of claim 9, further comprising:
determining, by the controller, that a sound signal of the occupant is detected when a sound signal of the occupant received by the microphone corresponds to a predetermined sound signal; and
executing, by the controller, the predetermined application program.

11. The method of claim 10, further comprising:
determining, by the controller, that a motion signal of the occupant is detected when a motion signal of the occupant received from the proximity sensor corresponds to a predetermined motion signal; and
executing, by the controller, the predetermined application program.

12. The method of claim 12, further comprising:
setting, by the controller, a sensing range of the proximity sensor to a maximum sensing range in response to detecting an occupant within the vehicle; and
limiting, by the controller, motion signal input to the proximity sensor when the motion signal of the occupant is detected.

13. A non-transitory computer readable medium containing program instructions executed by a controller, the computer readable medium comprising:
program instructions that control an entrance detector configured to detect presence of occupant within a vehicle by detecting a connection with a connectivity module disposed within the vehicle or connectivity module connected to an on board diagnostics (OBD) connector; and
program instructions that execute a predetermined application program when presence of the occupant is detected.

14. The non-transitory computer readable medium of claim 13, further comprising:
program instructions that control a sensor configured to receive an operating signal of the occupant; and
program instructions that control a sensor detector configured to detect receipt of the operating signal from the sensor; and
program instructions that execute an application program according to the operating signal of the occupant detected by the sensor detector.

15. The non-transitory computer readable medium of claim 14, wherein the sensor is any one selected from a group consisting of: a microphone configured to detect a sound signal generated by the occupant, a magnetic sensor configured to detect a magnetic signal generated by operation of the occupant, and a proximity sensor configured to detect a motion signal of the occupant.

16. The non-transitory computer readable medium of claim 15, further comprising:
program instructions that determine that a sound signal of the occupant is detected when a sound signal of the occupant received by the microphone corresponds to a predetermined sound signal, and execute the predetermined application program.

17. The non-transitory computer readable medium of claim 15, further comprising:
program instructions that determine that a motion signal of the occupant is detected when a motion signal of the occupant received from the proximity sensor corresponds to a predetermined motion signal and execute the predetermined application program.

18. The non-transitory computer readable medium of claim 17, further comprising:
program instructions that set a sensing range of the proximity sensor to a maximum sensing range in response to detecting an occupant within the vehicle; and
program instructions that limit motion signal input to the proximity sensor when the motion signal of the occupant is detected.
